(19) United States
(12) Patent Application Publication
(10) Pub. No.: US 2010/0212220 A1
(43) Pub. Date: Aug. 26, 2010

(54) PROCESS FOR COMBINED BIODIESEL AND ALCOHOL PRODUCTION, AND FUEL COMPOSITIONS PRODUCED THEREFROM

(75) Inventor: Shakeel H. TIRMIZI, Matawan, NJ (US)

Correspondence Address: Range Fuels, Inc.;Attn: Ryan O''Connor, 11101 West 120th Ave., Suite 200, Broomfield, CO, 80021, US

(73) Assignee: Range Fuels, Inc., Broomfield, CO (US)

(21) Appl. No.: 12/706,908

(22) Filed: Feb. 17, 2010

Related U.S. Application Data
(60) Provisional application No. 61/154,021, filed on Feb. 20, 2009.

(51) Int. Cl. C10L 1/19; C11C 3/00

(52) U.S. Cl. 44/389; 554/170

(57) ABSTRACT

Improvements to biodiesel compositions, and methods for making those compositions more efficiently, are provided. Some variations of this invention provide processes for producing biodiesel and at least one C₁-C₄ alcohol, such as ethanol. Other variations provide certain biodiesel compositions containing C₂₊ alkyl esters. In some embodiments, biodiesel compositions are produced entirely from renewable resources.

### PRIORITY DATA

This patent application claims priority under 35 U.S.C. §120 from U.S. Provisional Patent Application No. 61/154,021, filed Feb. 20, 2009, the disclosure of which is hereby incorporated by reference herein for all purposes.

### FIELD OF THE INVENTION

The present invention generally relates to processes for the conversion of synthesis gas into renewable liquid fuels.

### BACKGROUND OF THE INVENTION

Synthesis gas, which is also known as syngas, is a mixture of gases comprising carbon monoxide (CO) and hydrogen (H₂). Generally, syngas may be produced from any carbonaceous material. In particular, biomass such as agricultural wastes, forest products, grasses, and other cellulosic material may be converted to syngas.

Syngas is a platform intermediate in the chemical and biorefining industries and has a vast number of uses. Syngas can be converted into alkanes, olefins, oxygenates, and alcohols such as ethanol. These chemicals can be blended into, or used directly as, diesel fuel, gasoline, and other liquid fuels. Syngas can also be directly combusted to produce heat and power. The substitution of alcohols and/or derivatives of alcohols in place of petroleum-based fuels and fuel additives can be particularly environmentally friendly when the alcohols are produced from feed materials other than fossil fuels.

Diesel fuel is a refined petroleum product which is burned in the engines powering most of the world's trains, ships, and large trucks. Petroleum is a non-renewable resource of finite supply. Acute shortages and dramatic price increases in petroleum and the refined products derived from petroleum have occurred, particularly during the past several decades. Further, diesel engines emit relatively high levels of certain pollutants, especially particulates. Accordingly, extensive research is now being directed toward replacing some or all petroleum-based diesel fuel with a cleaner-burning fuel derived from a renewable resource.

Biodiesel is one such non-petroleum-based diesel fuel. Biodiesel generally refers to a fuel comprising mono-alkyl esters of long-chain fatty acids derived from vegetable oils or animal fats. It can be used directly as fuel or as an additive, generally in a blend with petroleum-based diesel fuel.

Advantages of conventional biodiesel are known. Biodiesel offers similar fuel economy, horsepower, and torque as petroleum diesel while providing superior lubricity. Its use results in a substantial reduction of emissions of unburned hydrocarbons, carbon monoxide, and particulate matter. Biodiesel is therefore regarded as a renewable, non-toxic, and biodegradable fuel alternative or additive.

Production of biodiesel typically comprises the transesterification of fatty acids of a feedstock (e.g., fats and/or waste oils) into fatty-acid alkyl esters. Natural fats and oils generally contain free fatty acids as either a naturally occurring component or as a result of an enzymatic decomposition process. Generally, the transesterification reaction is carried out in the presence of an alcohol and a catalyst. The alcohol is normally methanol.

Improvements to biodiesel compositions, and methods for making those compositions more efficiently, are still needed commercially. For example, it is desirable to produce biodiesel fuels using mixtures of alcohols, which can be produced from syngas over mixed-alcohol catalysts.

### SUMMARY OF THE INVENTION

In some variations, this invention provides a process for producing biodiesel and at least one C₁-C₄ alcohol, the process comprising:

(a) providing a first input stream comprising syngas;

(b) reacting the syngas over an alcohol-synthesis catalyst under conditions effective for the conversion of at least some of the syngas to an alcohol, thereby forming a first output stream;

(c) providing a second input stream comprising a triglyceride;

(d) combining the second input stream with at least a portion of the first output stream under conditions effective for transesterification, optionally in the presence of an esterification catalyst, thereby forming a second output stream comprising biodiesel, glycerol, and at least one C₁-C₄ alcohol; and

(e) separating the second output stream into a third output stream and a fourth output stream, wherein the third output stream comprises the biodiesel, and wherein the fourth output stream comprises the at least one C₁-C₄ alcohol.

In some embodiments, the process further includes distilling the fourth output stream and recovering one or more purified C₁-C₄ alcohols.

In some embodiments, the third output stream comprises glycerol, which can be recovered if desired. In some embodiments, the fourth output stream comprises glycerol, which can be recovered.

Some embodiments further comprise removing at least a portion of water present in the fourth output stream, thereby forming a dehydrated fourth output stream. This dehydrated fourth output stream can be distilled to recover one or more purified C₁-C₄ alcohols, such as methanol, ethanol, propanol, butanol, and/or or higher alcohols (including all isomers). Some embodiments include removing water from the first output stream prior to step (d).

In various embodiments, the transesterification comprises the reaction of the triglyceride with ethanol, propanol, butanol, or any mixture of these. The biodiesel produced can include an ethyl ester, a propyl ester, and/or a butyl ester of a fatty acid derived from the triglyceride.

In certain embodiments, the biodiesel comprises an alkyl ester of a fatty acid derived from the triglyceride, the alkyl group including at least 5 carbon atoms.

In other variations of the invention, a process is provided for producing biodiesel and at least one C₁-C₄ alcohol, the process comprising:

(a) providing a first input stream comprising syngas;

(b) reacting the syngas over an alcohol-synthesis catalyst under conditions effective for the conversion of at least some of the syngas to an alcohol, thereby forming a first output stream;

(c) separating the first output stream into at least a second and third output stream, wherein the second output stream comprises methanol and/or ethanol, and wherein the third output stream comprises at least one alcohol selected from the group consisting of ethanol, propanol and butanol;

(d) providing a second input stream comprising a triglyceride;

(e) combining the second input stream with at least a portion of the third output stream under conditions effective for transesterification, optionally in the presence of an esterification catalyst, thereby forming a fourth output stream comprising biodiesel, glycerol, and unreacted alcohol, if any; and

(f) recovering at least some of the biodiesel from the fourth output stream.

In some embodiments, the process further includes distilling the second output stream and recovering one or more purified C₁-C₄ alcohols. Optionally, the process can include recovering a portion of the unreacted alcohol contained in the fourth output stream. This unreacted alcohol can be recycled and combined with the first output stream to carry out step (c). In some embodiments, the recovered alcohol is not recycled. Glycerol can be recovered from the fourth output stream.

In some embodiments, the process includes removing at least a portion of water present in the first output stream, thereby forming a dehydrated first output stream. The dehydrated first output stream can be distilled, for example, to recover one or more purified C₁-C₄ alcohols, such as ethanol. Water can be removed from the third output stream prior to step (e).

The transesterification reaction for this process variation can include the reaction of the triglyceride with ethanol, propanol, butanol, and/or higher alcohols, as well as any combinations of the foregoing.

The biodiesel can include one or more ethyl, propyl, and/or butyl esters of a fatty acid derived from the triglyceride. In some embodiments, the biodiesel comprises an alkyl ester of a fatty acid derived from the triglyceride, the alkyl group including at least 5 carbon atoms.

In any process of the invention, the syngas can be derived from a carbonaceous feedstock, which can be non-renewable but is preferably renewable, such as cellulosic biomass (e.g., wood or wood waste).

In some embodiments, methods of the invention further include blending the biodiesel with diesel fuel. In some embodiments, methods further include combusting the biodiesel (or diesel/biodiesel blend) in an internal combustion engine.

Other variations of this invention relate to compositions. Some variations provide a biodiesel composition in accordance with any of the processes described herein. Other variations provide new biodiesel compositions in general, regardless of the process used to produce those compositions.

In preferred embodiments, the invention provides a composition comprising a plurality of alkyl esters of fatty acids, wherein the average number of carbons contained in the alkyl groups of the plurality of alkyl esters is greater than 1, such as greater than about 1.5, or greater than about 2.

Some embodiments teach that at least a portion of the alkyl groups are butyl groups. In certain embodiments, at least a portion of the alkyl groups contain 5 or more carbon atoms.

In some particular embodiments, the alkyl esters have a bimodal carbon number distribution with a first peak at a carbon number of about 1 and a second peak at a carbon number of greater than 2. This second peak can occur, for example, as a carbon number of at least 2.5, 3.0, or greater.

The plurality of alkyl esters can comprise less than 50% methyl esters and greater than 10% alkyl esters of C₃ or higher. In some embodiments, the plurality of alkyl esters comprises less than 25%, such as less than 10%, or less than 2%, methyl esters. The plurality of alkyl esters can comprise greater than 25% alkyl esters of C₃ or higher. In certain embodiments, such as when ethanol is a desired alcohol product, the plurality of alkyl esters does not substantially include ethyl esters.

In preferred embodiments relating to compositions, the invention provides a composition comprising a plurality of alkyl esters of fatty acids, the composition including from 10-90% methyl esters and 10-90% alkyl esters of C₃ or higher.

For example, the composition can include from 25-75% methyl esters and 25-75% alkyl esters of C₃ or higher. The composition can include less than 10% ethyl esters, such as less than 2% ethyl esters, or substantially no ethyl esters.

In some compositions, one or more aliphatic hydrocarbons are present. In some compositions, one or more aromatic hydrocarbons are present.

Preferred compositions are capable of burning in an internal combustion engine. Preferred compositions are suitable as a diesel fuel.

In some embodiments, the biodiesel composition meets the specification set forth in ASTM D975 and/or ASTM D396-08c. In some embodiments, the composition further comprises a diesel fuel in a suitable blend, wherein the blend meets the specification set forth in ASTM D7467-08.

### BRIEF DESCRIPTION OF THE FIGURES

FIG. 1 is a simplified block-flow diagram depicting an exemplary process for producing biodiesel and fuel-grade alcohol, according to some embodiments of the invention

FIG. 2 is a simplified block-flow diagram depicting another exemplary process for producing biodiesel and fuel-grade alcohol, according to some embodiments of the invention.

These and other embodiments, features, and advantages of the present invention will become more apparent to those skilled in the art when taken with reference to the following detailed description of the invention in conjunction with the accompanying drawings.

### DETAILED DESCRIPTION OF EMBODIMENTS OF THE INVENTION

Certain embodiments of the present invention will now be further described in more detail, in a manner that enables the claimed invention so that a person of ordinary skill in this art can make and use the present invention.

Unless otherwise indicated, all numbers expressing reaction conditions, stoichiometries, concentrations of components, and so forth used in the specification and claims are to be understood as being modified in all instances by the term “about.” Accordingly, unless indicated to the contrary, the numerical parameters set forth in the following specification and attached claims are approximations that may vary depending at least upon the specific analytical technique. Any numerical value inherently contains certain errors necessarily resulting from the standard deviation found in its respective testing measurements.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs. If a definition set forth in this section is contrary to or otherwise inconsistent with a definition set forth in patents, published patent applications, and other publications that are herein incorporated by reference, the definition set forth in this specification prevails over the definition that is incorporated herein by reference.

Triglycerides are esters of glycerol, CH₂(OH)CH(OH)CH₂(OH), and three fatty acids. Fatty acids are aliphatic compounds containing 4 to 24 carbon atoms and having a terminal carboxyl group. Diglycerides are esters of glycerol and two fatty acids, and monoglycerides are esters of glycerol and one fatty acid. Naturally occurring fatty acids, with minor exceptions, have an even number of carbon atoms. Triglycerides are found in a large variety of fats and oils, including natural oils (e.g., soybean oil) as well as industrial and commercial waste oils (e.g., restaurant grease).

The present invention will now be described by reference to the figures. This exemplary detailed description illustrates by way of example, not by way of limitation, the principles of the invention.

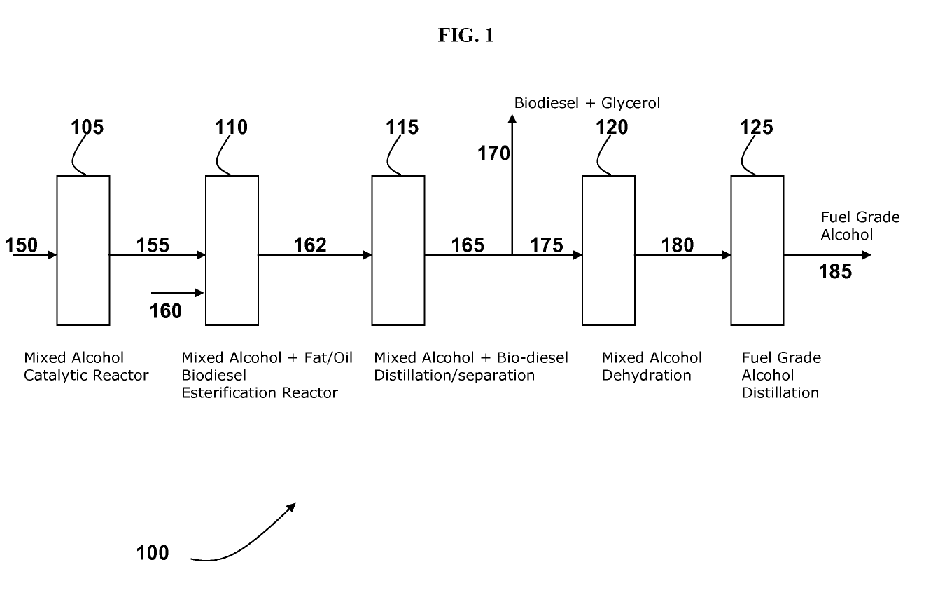

In FIG. 1, a process block-flow diagram is shown for a process 100 of the invention. Process 100 is a method for producing biodiesel and at least one C₁-C₄ alcohol.

An input stream 150 comprising syngas is provided to an alcohol-synthesis reactor 105. Syngas is converted to one or more C₁-C₄ alcohols in reactor 105 under conditions effective for the conversion of at least some of the syngas to an alcohol. Stream 155 exits from reactor 105.

Stream 155 enters reactor 110. An input stream 160 comprising a triglyceride is provided and fed to reactor 110. Streams 155 and 160 can also be mixed, at least in part, prior to feeding to reactor 110. Reactor 110 includes conditions effective for transesterification, optionally in the presence of an esterification catalyst, thereby forming an output stream 162 comprising biodiesel, glycerol, and at least one C₁-C₄ alcohol.

Stream 162 is fed to a separation unit 115 effective for separating the stream 162 into an output stream 170 comprising biodiesel, and an output stream 175 comprising at least one C₁-C₄ alcohol. This separation unit 115 is preferably one or more distillation columns, but any other known means of separation can be used. Other separation techniques can include or use flash vessels, centrifuges, cyclones, membranes, filters, and so on. Separation can be principally based, for example, on distillation, absorption, adsorption, or diffusion, and can utilize differences in vapor pressure, activity, molecular weight, density, viscosity, chemical functionality, and any combinations thereof. Stream 170 can be further treated to recover purified biodiesel.

With continued reference to FIG. 1, stream 175 is fed to a dehydration unit 120 wherein at least some water is removed using, for example, a molecular sieve. Exemplary dehydration units are provided in U.S. patent application Ser. No. 12/166,212, entitled “METHODS AND APPARATUS FOR PRODUCING ALCOHOLS FROM SYNGAS,” filed Jul. 1, 2008, whose assignee is the same as the assignee of this patent application, and which is hereby incorporated herein by reference.

The dehydrated stream is stream 180 which is fed to another separation unit 125 for purification of one or more alcohols. This separation unit 125 is preferably one or more distillation columns, but any other known means of separation can be used, including means recited with respect to unit 115. Fuel-grade alcohol is produced in stream 185.

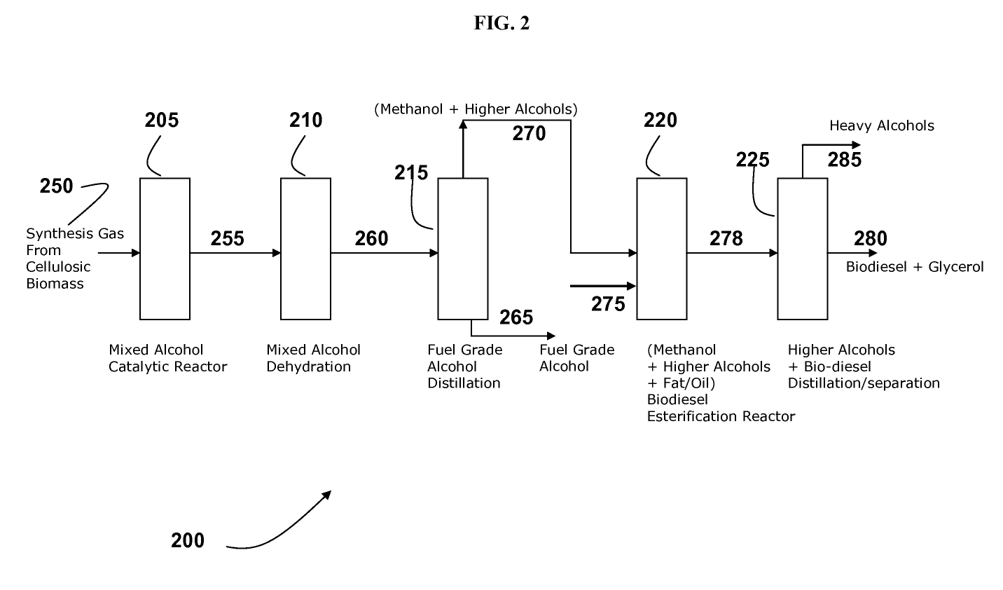

In FIG. 2, a process block-flow diagram is shown for another process 200 of the invention. Process 200 is a method for producing biodiesel and at least one C₁-C₄ alcohol.

An input stream 250 comprising syngas is provided to an alcohol-synthesis reactor 205. In the embodiment depicted in FIG. 2, the syngas is derived from cellulosic biomass. Syngas is converted to one or more C₁-C₄ alcohols in reactor 205 under conditions effective for the conversion of at least some of the syngas to an alcohol. Stream 255 exits from reactor 105.

Stream 255 is fed to a dehydration unit 210 wherein at least some water is removed using, for example, a molecular sieve. The dehydrated stream is stream 260 which is fed to a separation unit 215 for separation of one or more alcohols. This separation unit 215 is preferably one or more distillation columns, but any other known means of separation can be used. Other separation techniques can include or use flash vessels, centrifuges, cyclones, membranes, filters, and so on. Separation can be principally based, for example, on distillation, absorption, adsorption, or diffusion, and can utilize differences in vapor pressure, activity, molecular weight, density, viscosity, chemical functionality, and any combinations thereof.

Separation unit 215 separates stream 260 into an output stream 265 comprising methanol and/or ethanol, and another output stream 270 comprising at least one alcohol selected from the group consisting of ethanol, propanol and butanol. The methanol and/or ethanol in stream 265 can be used, or further treated to produce, fuel-grade alcohol.

Stream 270, which contains higher alcohols, is then combined with an input stream 275 comprising a triglyceride under conditions effective for transesterification, optionally in the presence of an esterification catalyst, thereby forming an output stream 278 comprising biodiesel, glycerol, and unreacted alcohol, if any. Biodiesel can be recovered by feeding stream 278 to a separation unit 225, suitable for separating biodiesel from one or more alcohols. This separation unit 225 is preferably one or more distillation columns, but any other known means of separation can be used, including means recited with respect to unit 215.

In some embodiments, syngas for streams 150 or 250 is produced from one or more carbon-containing feedstocks selected from timber harvesting residues, softwood chips, hardwood chips, tree branches, tree stumps, leaves, bark, sawdust, paper pulp, corn stover, wheat straw, rice straw, sugarcane bagasse, switchgrass, miscanthus, animal manure, municipal solid waste, municipal sewage, commercial waste, used tires, grape pumice, almond shells, pecan shells, coconut shells, coffee grounds, grass pellets, hay pellets, wood pellets, cardboard, paper, plastic, rubber, cloth, coal, lignite, coke, lignin, and/or petroleum. Mixtures of any of these feedstocks can be used.

Syngas for stream 150 or 250 can be produced by any known means, such as by one or more of gasification, pyrolysis, devolatilization, steam reforming, and partial oxidation of one or more feedstocks recited herein.

In some embodiments, syngas is produced by the methods taught in U.S. patent application Ser. No. 12/166,167, entitled “METHODS AND APPARATUS FOR PRODUCING SYNGAS,” filed Jul. 1, 2008, whose assignee is the same as the assignee of this patent application, and which is hereby incorporated herein by reference.

The syngas is converted to alcohols in reactor 105 or 205. Syngas can be selectively converted to selected C₁-C₄ alcohols by means of a chemical catalyst, such as described in U.S. patent application Ser. No. 12/166,203, entitled “METHODS AND APPARATUS FOR PRODUCING ALCOHOLS FROM SYNGAS,” filed Jul. 1, 2008, whose assignee is the same as the assignee of this patent application, and which is hereby incorporated herein by reference.

Reactor 105 or 205 may be any type of catalytic reactor suitable for the conversion of syngas to alcohol mixtures. Reactor 105 may, for example, be any suitable fixed-bed reactor. In some variations, reactor 105 or 205 comprises tubes filled with one or more catalysts. Syngas passing through the tubes undergoes catalyzed reactions to form alcohols or other products.

Reactor 105 may operate, for example, at temperatures of about 400° F. to about 700° F. and at pressures of about 500 psig to about 2500 psig. In some embodiments, the temperature is between about 400° F. to about 500° F., about 500° F. to about 600° F., or about 600° F. to about 700° F. In some embodiments, the pressure is about 500 psig to about 1000 psig, about 1000 psig to about 2000 psig, or about 2000 psig to about 2500 psig.

In some embodiments, conditions effective for producing alcohols from syngas include average reactor residence times from about 0.1-10 seconds, preferably about 0.5-2 seconds. “Average reactor residence time” is the mean of the residence-time distribution of the reactor contents under actual operating conditions. Catalyst contact times can also be calculated by a skilled artisan and these times will typically also be in the range of 0.1-10 seconds, although it will be appreciated that it is certainly possible to operate at shorter or longer times.

The reactor for converting syngas into alcohols can be engineered and operated in a wide variety of ways. The reactor operation can be continuous, semicontinuous, or batch. Operation that is substantially continuous and at steady state is preferable. The flow pattern can be substantially plug flow, substantially well-mixed, or a flow pattern between these extremes. The flow direction can be vertical-upflow, vertical-downflow, or horizontal. A vertical configuration can be preferable.

Any “reactor” used herein (e.g., 105, 110, 205, or 220) can in fact be a series or network of several reactors in various arrangements. For example, in some variations, the reactor comprises a large number of tubes filled with one or more catalysts.

Any suitable catalyst or combination of catalysts may be used in reactor 105 or 205. Suitable catalysts may include, but are not limited to, one or more of ZnO/Cr₂O₃, Cu/ZnO, Cu/ZnO/Al₂O₃, Cu/ZnO/Cr₂O₃, Cu/ThO₂, Co/Mo/S, Co/S, Mo/S, Ni/S, Ni/Mo/S, Ni/Co/Mo/S, Rh, Ti, Fe, Ir, and any of the foregoing in combination with Mn and/or V. The addition of basic promoters (e.g. K, Li, Na, Rb, Cs, and Fr) increases the activity and selectivity of some of these catalysts for alcohols. Basic promoters include alkaline-earth and rare-earth metals. Non-metallic bases can also serve as effective promoters, in some embodiments.

The catalyst phase can be a packed bed or a fluidized bed. The catalyst particles can be sized and configured such that the chemistry is, in some embodiments, mass-transfer-limited or kinetically limited. The catalyst can take the form of a powder, pellets, granules, beads, extrudates, and so on. When a catalyst support is optionally employed, the support may assume any physical form such as pellets, spheres, monolithic channels, etc. The supports may be coprecipitated with active metal species; or the support may be treated with the catalytic metal species and then used as is or formed into the aforementioned shapes; or the support may be formed into the aforementioned shapes and then treated with the catalytic species.

Reactor 110 or 220 may be any type of reactor suitable for carrying out transesterification. Reactor 110 or 220 can consist of a simple vessel or tank, which can be stirred or unstirred. Preferably, reactor 110 or 220 is a closed reaction vessel, to prevent loss of alcohol to the atmosphere. The reaction can be conducted batch-wise, continuously, or semi-continuously. Batch reactions can be easier to control. Continuous transesterification reactions can reduce reaction times.

The reaction temperature for the process step conducted in reactor 110 or 220 is not regarded as critical, but it is preferable to maintain the temperature above the boiling point of one or more alcohols present, to speed up the reaction. Exemplary temperatures include about 150-250° F., such as about 175° F. Excess alcohol can be used to increase transesterification reaction rates or to maintain favorable reaction equilibrium.

The transesterification in reactor 110 or 220 can be catalyzed with one or more acids or bases. It is generally preferred to employ base-catalyzed transesterification, as is known in the art, due to lower temperatures (and therefore pressures) possible, higher yields, reduced side reactions, and less-expensive materials of construction. Base catalysts can be, for example, sodium hydroxide or potassium hydroxide, although other bases can be used. Acid catalysts can be, for example, sulfuric acid, hydrochloric acid, and other acids. The transesterification in reactor 110 or 220 can be conducted in a substantially non-catalytic manner, recognizing that there can be various impurities present that may contribute some catalytic effect.

The reaction time for the process step conducted in reactor 110 or 220 is not regarded as critical, as long as it is suitable for a desired conversion. Exemplary reaction times include about 10 minutes to about 24 hours, such as about 1-8 hours.

In the present invention, it is preferable to use alcohols larger than methanol to conduct the transesterification reaction with triglycerides. Alcohols such as ethanol, propanol, butanol, and C₅₊ alcohols (including all isomers) can be desirable for several reasons.

Larger alcohols can have increased miscibility with the oil or fat that contains the reactant species (triglycerides). A homogeneous phase in the reactor 110 or 220 is expected to reduce mass-transfer effects and/or enhance reaction rates. Another benefit to using longer-chain alcohols is that a higher reaction temperature can be used, because the boiling temperatures for the alcohols increase with chain length. The ability to run the transesterification reaction at higher temperatures can have a significant impact on the speed and efficiency of the desired chemistry. Higher reaction temperatures achievable with the longer-chain alcohols, coupled with the improved miscibility of the alcohols with hydrophobic triglycerides, can also allow for (in some embodiments) lower ratios of alcohol/fatty acid, thus minimizing costs and the quantity of unreacted materials.

In some embodiments, the process is controlled or adjusted to attain certain biodiesel properties. As is known, relevant biodiesel properties can include flash point, cetane number, energy content, cloud point, gel point, pour point, glycerol content, water content, sediment content, ash content, sulfur content, nitrogen content, phosphorus content, pH, density, viscosity, lubricity, and so on.

This invention also relates to novel and non-obvious compositions of the biodiesel fraction contained, for example, in stream 170 or 280, or as otherwise provided.

Other variations of this invention relate to compositions. Some variations provide a biodiesel composition in accordance with any of the processes described herein. Other variations provide new biodiesel compositions in general, regardless of the process used to produce those compositions.

In preferred embodiments, the invention provides a composition comprising a plurality of alkyl esters of fatty acids, wherein the average number of carbons contained in the alkyl groups of the plurality of alkyl esters is greater than 1, such as greater than about 1.5, or greater than about 2.

Some embodiments teach that at least a portion of the alkyl groups are butyl groups. In certain embodiments, at least a portion of the alkyl groups contain 5 or more carbon atoms.

In some particular embodiments, the alkyl esters have a bimodal carbon number distribution with a first peak at a carbon number of about 1 and a second peak at a carbon number of greater than 2. This second peak can occur, for example, as a carbon number of at least 2.5, 3.0, or greater.

A bimodal carbon number distribution can arise according to the present invention when a certain alcohol is a desired product, thereby decreasing the concentration of alkyl groups having the carbon number of the alcohol product. An exemplary embodiment is for combined ethanol and biodiesel production, wherein methanol and C₃₊ alcohols produced during alcohol synthesis are used for biodiesel production. It should be noted that a bimodal carbon number distribution does not mean that there is no biodiesel present having alkyl esters with a carbon number between the modes. For example, even when ethanol is a desired product, some ethyl esters would be expected in the biodiesel product.

The plurality of alkyl esters can comprise less than 50% methyl esters and greater than 10% alkyl esters of C₃ or higher. In some embodiments, the plurality of alkyl esters comprises less than 25%, such as less than 10%, or less than 2%, methyl esters. The plurality of alkyl esters can comprise greater than 25% alkyl esters of C₃ or higher. In certain embodiments, such as when ethanol is a desired alcohol product, the plurality of alkyl esters does not substantially include ethyl esters.

In preferred embodiments relating to compositions, the invention provides a composition comprising a plurality of alkyl esters of fatty acids, the composition including from 10-90% methyl esters and 10-90% alkyl esters of C₃ or higher.

For example, the composition can include from 25-75% methyl esters and 25-75% alkyl esters of C₃ or higher. The composition can include less than 10% ethyl esters, such as less than 2% ethyl esters, or substantially no ethyl esters.

In some compositions, one or more aliphatic hydrocarbons are present. In some compositions, one or more aromatic hydrocarbons are present.

Preferred compositions are capable of burning in an internal combustion engine. Preferred compositions are suitable as a diesel fuel.

In some embodiments, the biodiesel composition meets the specification set forth in ASTM D975 and/or ASTM D396-08c. In some embodiments, the composition further comprises a diesel fuel in a suitable blend, wherein the blend meets the specification set forth in ASTM D7467-08.

In some embodiments, biodiesel compositions can further comprise one or more surfactants. A number of patents, including U.S. Pat. Nos. 6,129,773; 6,348,074; 4,477,258; and 4,451,265 describe surfactant systems containing long-chain fatty acids or derivatives thereof.

Some variations produce or provide biodiesel mixed with alcohols, which alcohols can be (but are not necessarily) produced by the methods of the invention.

Preferred embodiments of the invention can reduce overall energy intensity and/or reduce the number of processing steps to manufacture biodiesel fuels, while producing “green biodiesel” having improved compositions and/or properties.

All publications, patents, and patent applications cited in this specification are incorporated herein by reference in their entirety as if each publication, patent, or patent application was specifically and individually put forth herein. All ASTM specifications recited herein are also incorporated by reference.

In this detailed description, reference has been made to multiple embodiments of the invention and non-limiting examples relating to how the invention can be understood and practiced. Other embodiments that do not provide all of the features and advantages set forth herein may be utilized, without departing from the spirit and scope of the present invention. This invention incorporates routine experimentation and optimization of the methods and systems described herein. Such modifications and variations are considered to be within the scope of the invention defined by the claims.

Where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially.

Therefore, to the extent that there are variations of the invention, which are within the spirit of the disclosure or equivalent to the inventions found in the appended claims, it is the intent that this patent will cover those variations as well. The present invention shall only be limited by what is claimed.

What is claimed is:

1. A process for producing biodiesel and at least one C₁-C₄ alcohol, said process comprising:
(a) providing a first input stream comprising syngas;
(b) reacting said syngas over an alcohol-synthesis catalyst under conditions effective for the conversion of at least some of said syngas to an alcohol, thereby forming a first output stream;
(c) providing a second input stream comprising a triglyceride;
(d) combining said second input stream with at least a portion of said first output stream under conditions effective for transesterification, optionally in the presence of an esterification catalyst, thereby forming a second output stream comprising biodiesel, glycerol, and at least one C₁-C₄ alcohol; and
(e) separating said second output stream into a third output stream and a fourth output stream, wherein said third output stream comprises said biodiesel, and wherein said fourth output stream comprises said at least one C₁-C₄ alcohol.

2. The process of claim 1, further comprising distilling said fourth output stream and recovering one or more purified C₁-C₄ alcohols.

3. The process of claim 1, wherein said third output stream comprises glycerol.

4. The process of claim 1, wherein said fourth output stream comprises glycerol.

5. The process of claim 3, further comprising recovering glycerol from said third output stream.

6. The process of claim 4, further comprising recovering glycerol from said fourth output stream.

7. The process of claim 1, further comprising removing at least a portion of water present in said fourth output stream, thereby forming a dehydrated fourth output stream.

8. The process of claim 7, further comprising distilling said dehydrated fourth output stream and recovering one or more purified C₁-C₄ alcohols.

9. The process of claim 1, wherein said transesterification comprises the reaction of said triglyceride with ethanol.

10. The process of claim 1, wherein said transesterification comprises the reaction of said triglyceride with propanol.

11. The process of claim 1, wherein said transesterification comprises the reaction of said triglyceride with butanol.

12. The process of claim 1, wherein said biodiesel comprises an alkyl ester of a fatty acid derived from said triglyceride, said alkyl group including at least 5 carbon atoms.

13. The process of claim 1, further comprising removing water from said first output stream prior to step (d).

14. A process for producing biodiesel and at least one C₁-C₄ alcohol, said process comprising:
(a) providing a first input stream comprising syngas;
(b) reacting said syngas over an alcohol-synthesis catalyst under conditions effective for the conversion of at least some of said syngas to an alcohol, thereby forming a first output stream;
(c) separating said first output stream into at least a second and third output stream, wherein said second output stream comprises methanol and/or ethanol, and wherein said third output stream comprises at least one alcohol selected from the group consisting of ethanol, propanol and butanol;
(d) providing a second input stream comprising a triglyceride;
(e) combining said second input stream with at least a portion of said third output stream under conditions effective for transesterification, optionally in the presence of an esterification catalyst, thereby forming a fourth output stream comprising biodiesel, glycerol, and unreacted alcohol, if any; and
(f) recovering at least some of said biodiesel from said fourth output stream.

15. The process of claim 14, further comprising distilling said second output stream and recovering one or more purified C₁-C₄ alcohols.

16. The process of claim 14, further comprising recovering a portion of said unreacted alcohol contained in said fourth output stream.

17. The process of claim 16, further comprising recycling said portion of said unreacted alcohol to be combined with said first output stream to carry out step (c).

18. The process of claim 14, further comprising recovering glycerol from said fourth output stream.

19. The process of claim 14, further comprising removing at least a portion of water present in said first output stream, thereby forming a dehydrated first output stream.

20. The process of claim 19, further comprising distilling said dehydrated first output stream and recovering one or more purified C₁-C₄ alcohols.

21. The process of claim 14, wherein said transesterification comprises the reaction of said triglyceride with ethanol.

22. The process of claim 14, wherein said transesterification comprises the reaction of said triglyceride with propanol.

23. The process of claim 14, wherein said transesterification comprises the reaction of said triglyceride with butanol.

24. The process of claim 14, wherein said biodiesel comprises an alkyl ester of a fatty acid derived from said triglyceride, said alkyl group including at least 5 carbon atoms.

25. The process of claim 14, further comprising removing water from said third output stream prior to step (e).

26. A composition comprising a plurality of alkyl esters of fatty acids, wherein the average number of carbons contained in said alkyl groups of said plurality of alkyl esters is greater than 1.

27. The composition of claim 26, wherein said average number of carbons is greater than about 1.5.

28. The composition of claim 26, wherein said average number of carbons is greater than about 2.

29. The composition of claim 26, wherein at least a portion of said alkyl groups are butyl groups.

30. The composition of claim 26, wherein at least a portion of said alkyl groups contain 5 or more carbon atoms.

31. The composition of claim 26, wherein said alkyl esters have a bimodal carbon number distribution with a first peak at a carbon number of about 1 and a second peak at a carbon number of greater than 2.

32. The composition of claim 31, wherein said second peak occurs at a carbon number of at least 2.5.

33. The composition of claim 31, wherein said second peak occurs at a carbon number of at least 3.

34. The composition of claim 26, wherein said plurality of alkyl esters comprises less than 50% methyl esters and greater than 10% alkyl esters of C₃ or higher.

35. The composition of claim 34, wherein said plurality of alkyl esters comprises less than 25% methyl esters.

36. The composition of claim 34, wherein said plurality of alkyl esters comprises greater than 25% alkyl esters of C₃ or higher.

37. The composition of claim 34, wherein said plurality of alkyl esters comprises less than 10% ethyl esters.

38. The composition of claim 37, wherein said plurality of alkyl esters comprises less than 2% ethyl esters.

39. The composition of claim 38, wherein said plurality of alkyl esters does not substantially include ethyl esters.

40. A composition comprising a plurality of alkyl esters of fatty acids, said composition including from 10-90% methyl esters and 10-90% alkyl esters of C₃ or higher.

41. The composition of claim 40, said composition including from 25-75% methyl esters and 25-75% alkyl esters of C₃ or higher.

42. The composition of claim 40, said composition including less than 10% ethyl esters.

43. The composition of claim 42, said composition including less than 2% ethyl esters.

44. The composition of claim 43, said composition including substantially no ethyl esters.

45. The composition of claim 40, said composition further comprising one or more aliphatic hydrocarbons.

46. The composition of claim 40, said composition further comprising one or more aromatic hydrocarbons.

47. The composition of claim 40, wherein said composition is suitable as a diesel fuel or diesel fuel additive.

48. The composition of claim 40, wherein said composition meets the specification set forth in ASTM D975.

49. The composition of claim 40, wherein said composition meets the specification set forth in ASTM D396-08c.

50. The composition of claim 40, said composition further comprising a diesel fuel in a suitable blend, wherein said blend meets the specification set forth in ASTM D7467-08.
